(19) United States
(12) Patent Application Publication
(10) Pub. No.: US 2004/0005247 A1
(43) Pub. Date: Jan. 8, 2004

(54) Microfluidic closed-end metering systems and methods

(75) Inventor: Christoph D. Karp, Pasadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/190,092

(22) Filed: Jul. 3, 2002

(51) Int. Cl. B01L 3/02

(52) U.S. Cl. 422/100; 436/180

(57) ABSTRACT

Microfluidic devices and methods for metering discrete plugs of fluid are provided. The microfluidic devices include an actuating channel, a metering channel and a deformable membrane disposed therebetween. The metering channel is in fluid communication with a fluid source, but is otherwise closed. The pressure in the actuating channel is varied to deform the deformable membrane. The volume of the metering channel varies in proportion with the deformation of the deformable membrane, creating a pressure differential between the metering channel and the fluid source. The pressure differential causes fluid from the fluid source to be drawn into or expelled from the metering channel.

### FIELD OF THE INVENTION

The present invention relates to microfluidic devices and the control and metering of fluid within those devices. These devices are useful in various biological and chemical systems, particularly in systems where fluid metering is important, as well as in combination with other liquid-distribution devices.

### BACKGROUND OF THE INVENTION

There has been a growing interest in the manufacture and use of microfluidic systems for the acquisition of chemical and biological information. In particular, when conducted in microfluidic volumes, complex chemical and biochemical reactions may be carried out using very small volumes of liquid. Among other benefits, microfluidic systems improve the response time of reactions, minimize sample volume, and lower reagent consumption. When volatile or hazardous materials are used or generated, performing reactions in microfluidic volumes also enhances safety and reduces disposal quantities.

Traditionally, microfluidic devices have been constructed in a planar fashion using techniques that are borrowed from the silicon fabrication industry. Representative systems are described, for example, in some early work by Manz et al. (Trends in Anal. Chem. (1990) 10(5): 144-149; Advances in Chromatography (1993) 33: 1-66). In these publications, microfluidic devices are constructed by using photolithography to define channels on silicon or glass substrates and etching techniques to remove material from the substrate to form the channels. A cover plate is bonded to the top of the device to provide closure. Miniature pumps and valves can also be constructed to be integral (e.g., within) such devices. Alternatively, separate or off-line pumping mechanisms are contemplated.

More recently, a number of methods have been developed that allow microfluidic devices to be constructed from plastic, silicone or other polymeric materials. In one such method, a negative mold is first constructed, and plastic or silicone is then poured into or over the mold. The mold can be constructed using a silicon wafer (see, e.g., Duffy et al., Analytical Chemistry (1998) 70: 4974-4984; McCormick et. al., Analytical Chemistry (1997) 69: 2626-2630), or by building a traditional injection molding cavity for plastic devices. Some molding facilities have developed techniques to construct extremely small molds. Components constructed using a LIGA technique have been developed at the Karolsruhe Nuclear Research center in Germany (see, e.g., Schomburg et al., Journal of Micromechanical Microengineering (1994) 4: 186-191), and commercialized by MicroParts (Dortmund, Germany). Jenoptik (Jena, Germany) also uses LIGA and a hot-embossing technique. Imprinting methods in PMMA have also been demonstrated (see, Martynova et. al., Analytical Chemistry (1997) 69: 4783-4789). However, these techniques do not lend themselves to rapid prototyping and manufacturing flexibility. Additionally, the foregoing references teach only the preparation of planar microfluidic structures. Moreover, the tool-up costs for both of these techniques are quite high and can be cost-prohibitive.

A more recent method for constructing microfluidic devices uses a KrF laser to perform bulk laser ablation in fluorocarbons that have been compounded with carbon black to cause the fluorocarbon to be absorptive of the KrF laser (see, e.g., McNeely et al., “Hydrophobic Microfluidics,” SPIE Microfluidic Devices & Systems IV, Vol. 3877 (1999)). This method is reported to reduce prototyping time; however, the addition of carbon black renders the material optically impure and presents potential chemical compatibility issues. Additionally, the reference is directed only to planar structures.

Various conventional tools and combinations of tools are used when analyzing or synthesizing chemical or biological products in conventional macroscopic volumes. Such tools include, for example: metering devices, reactors, valves, heaters, coolers, mixers, splitters, diverters, cannulas, filters, condensers, incubators, separation devices, and catalyst devices. Attempts to perform chemical or biological synthesis and/or analysis in microfluidic volumes have been stifled by difficulties in making tools for analysis and/or synthesis at microfluidic scale and then integrating such tools into microfluidic devices. Another difficulty is accurately measuring stoichiometric microfluidic volumes of reagents and solvents to perform analysis and/or synthesis on a microfluidic scale. Additionally, difficulties in rapidly prototypic microfluidic devices are compounded by attempts to incorporate multiple analysis and/or synthesis tools for multi-step analysis and/or synthesis.

When working with fluids in conventional macroscopic volumes, fluid metering is relatively straightforward. In microfluidic volumes, however, fluid metering is considerably more difficult. Most, if not all, microfluidic systems require some interface to the conventional macrofluidic world. Using conventional macrofluidic techniques, the smallest volume of liquid that can be generated is a droplet, typically ranging in volume between approximately one to one hundred microliters. At the low end of this volumetric range it is extremely difficult to consistently create droplets having a reasonably low volumetric standard deviation. Applications in which fluidic metering accuracy is important include microfluidic synthesis, wherein it would be desirable to measure stoichiometric microfluidic volumes of reagents and solvents.

It is further difficult to segregate a small fluid volume from a larger bulk volume within a microfluidic device. Such segregation requires the forces of cohesion (interaction between like fluid molecules) and adhesion (interaction between fluid molecules and the surrounding conduit) to be overcome. It is believed that the general dominance of surface effects over momentum effects in microfluidic systems contributes to the challenge of performing fluid metering within such systems.

It may be desirable to analyze or examine a small fluid volume while it remains contained in the microfluidic device. However, it is difficult to position a small fluid volume in specific locations within a microfluidic device (such as under an optical window) to allow such analysis to take place. The small volume of liquid, small dimensions of a microfluidic structure, and physical limitations of mechanisms for moving fluids within a microfluidic device all contribute to the difficulty in precisely positioning fluid volume within a microfluidic device.

A known method of obtaining small droplets is to combine fluids to be metered with surfactants before dispensing the liquid through a pipette tip. But this method is unacceptable for many applications, since adding surfactants may detrimentally compromise the purity of the fluid to be metered, and it may be very challenging to remove the surfactants and purify the fluid for further processing or use.

One method for metering small volumes of fluids is described in co-pending U.S. patent application Ser. No. ______ (filed Jun. 27, 2002), which is owned by assignee of the present application. A primary or “trunk” channel is provided in conjunction with a vented microfluidic branch channel of a known volume. First, a fluid is directed into the trunk channel. Subsequently, a portion of the fluid is directed into the branch channel. The trunk channel may then be flushed, typically with a gas, leaving the portion of fluid in the branch channel. Because the branch channel is of a known volume, the volume of fluid contained in the branch also is known.

In order for a trunk/branch metering system to function, however, the branch channel must be vented in some manner. If the branch channel is not vented, any gas trapped in the branch channel by the fluid may form a bubble or otherwise occupy volume in the branch channel, thus creating error in the metered volume. The branch channel may be vented in a number of ways, including the use of a gas-permeable membrane that allows gas to pass through but restricts fluid flow. Also, multiple channels may be connected to a common vent channel. Alternatively, the branch channel may include a fluidic impedance that, at a given fluid pressure, prevents the flow of a liquid through the end of the branch channel while allowing gas to pass. Once the desired amount of fluid has been metered, the fluid pressure may be increased to overcome the impedance and expel the liquid volume through the impedance into a receptacle or other desirable structure or device.

Use of a permeable membrane to vent a branch channel may be undesirable because fluid may inadvertently escape through the membrane. For example, small amounts of fluid may seep through the membrane, or small tears or holes in the membrane, which may be difficult to detect, can allow fluid to pass through the membrane. In either event, even very small amounts of seepage or leakage can render the device inaccurate or inoperable. Moreover, even if no leakage or seepage occurs, the fluid may wet the porous membrane. In certain applications, devices with wetted membranes may not be re-used, as the wetting of a membrane may affect its performance in subsequent operations. Also, any fluid retained by the wetted membrane may contaminate subsequent operations.

Use of impedances to retain metered samples within a branch channel prior to dispensing also may be undesirable because fluids may be inadvertently dispensed before the metering operation is complete. For example, inadvertent over-pressurization of the branch channel may cause the fluid to escape prematurely, resulting in inaccurate metering. Furthermore, if the metering operation is being performed merely to sequester a given volume of the fluid for analysis and not for dispensing, the ability to pass the metered sample to a receptacle or other structure may not be necessary.

The use of porous membranes or impedance regions may increase the difficulty of controlling the position of fluid plug for analysis. Because there is no mechanism for physically holding the sample plug in one position, such a device would require sensors and control systems to identify the location of the sample plug, move the plug to the desired location, and hold the plug in place during the analytical operation. The small volume of the plug and the small dimensions of a microfluidic structure would require very sensitive sensors and/or control systems to overcome potential error inducing factors such as hysteresis, capillary action, and other system variables.

Accordingly, there exists a need for metering devices and methods capable of sequestering and/or dispensing microfluidic sample volumes of fluid from a larger fluid volume while minimizing the risk of premature or inadvertent release of the sample volume from the device. There also exists a need for metering devices and methods capable of sequestering microfluidic sample volumes of fluid from a larger fluid volume and holding the sample volume in a desired location for analysis.

### SUMMARY OF THE INVENTION

In another separate aspect of the invention, any of the foregoing separate aspects may be combined for additional advantage. These and other aspects and advantages of the invention will be apparent to the skilled artisan upon review of the following description, drawings and claims.

### BRIEF DESCRIPTION OF THE DRAWINGS

FIG. 1A is a perspective view of a portion of a closed-end metering microfluidic structure according to one embodiment of the present invention. FIG. 1B is a top view of the structure of FIG. 1A.

FIG. 2A is an exploded perspective view of a multi-layer, three-dimensional microfluidic device according to another embodiment of the present invention. FIG. 2B is a top view of the assembled device of FIG. 2A.

FIG. 3A is a partial cross-sectional view of the device of FIGS. 2A-2B, taken along section line “A”-“A.” FIG. 3B shows the same view as FIG. 3A, but with the device in a first operational state. FIG. 3C shows the same view as FIG. 3A, but with the device in a second operational state.

### DETAILED DESCRIPTION OF PREFERRED EMBODIMENTS OF THE INVENTION

Definitions

The terms “channel” or “chamber” as used herein are to be interpreted in a broad sense. Thus, they are not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete ratio of fluid for a specified ratio of time. “Channels” and “chambers” may be filled or may contain internal structures comprising, for example, valves, filters, and similar or equivalent components and materials.

The term “microfluidic” as used herein is to be understood to refer to structures or devices through which a fluid is capable of being passed or directed, wherein one or more of the dimensions is less than about five hundred microns or to fluidic volumes of less than or equal to about two microliters.

The term “microfluidic impedance” as used herein is to be understood, without any restriction thereto, to refer to structures within the microfluidic device that hinder fluid flow. The shape, geometry and material that comprise these devices are not limited to the specific examples provided herein.

The term “plug” as used herein refers to a discrete portion of fluid typically separated from a larger volume.

The term “self-adhesive tape” as used herein refers to a material layer or film having an integral adhesive coating on one or both sides.

The terms “stencil” or “stencil layer” as used herein refers to a material layer or sheet that is preferably substantially planar, through which one or more variously shaped and oriented channels have been cut or otherwise removed through the entire thickness of the layer, thus permitting substantial fluid movement within the layer (as opposed to simple through-holes for transmitting fluid through one layer to another layer). The outlines of the cut or otherwise removed portions form the lateral boundaries of microstructures that are completed when a stencil is sandwiched between other layers, such as substrates and/or other stencils. Stencil layers can be either substantially rigid or flexible (thus permitting one or more layers to be manipulated so as not to lie in a plane).

Microfluidic Devices Generally

In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filter materials. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

In another embodiment, device layers may be directly bonded without using adhesives to provide high bond strength (which is especially desirable for high-pressure applications) and eliminate potential compatibility problems between such adhesives and solvents and/or samples. Specific examples of methods for directly bonding layers of non-biaxially-oriented polypropylene to form stencil-based microfluidic structures are disclosed in co-pending U.S. Provisional Patent Application Serial No. 60/338,286 (filed Dec. 6, 2001), which is owned by assignee of the present application and incorporated by reference as if fully set forth herein. In one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Preferred Embodiments

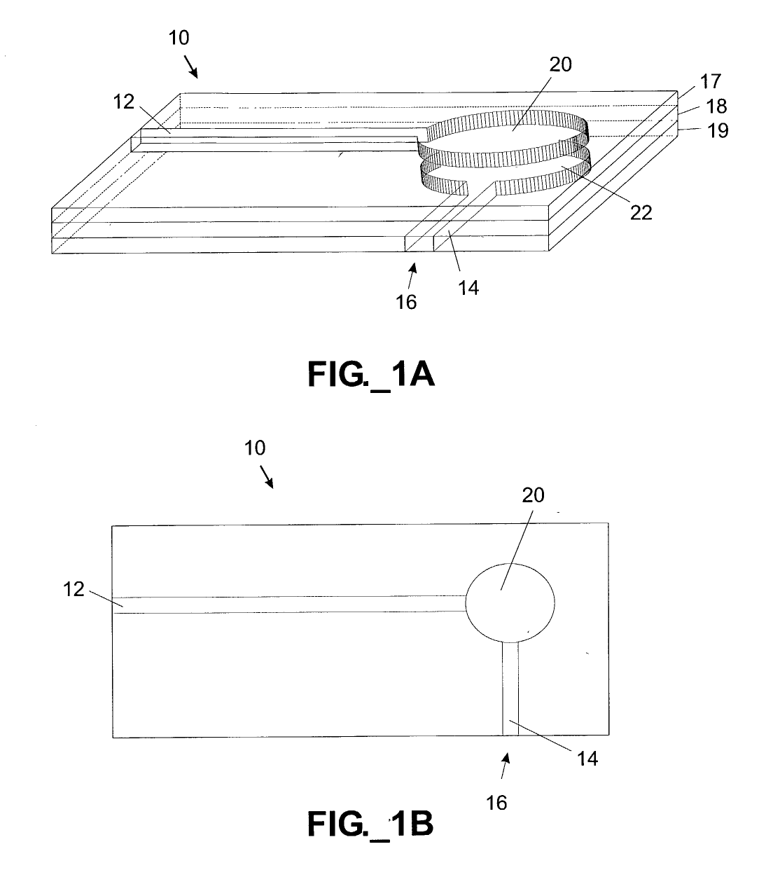

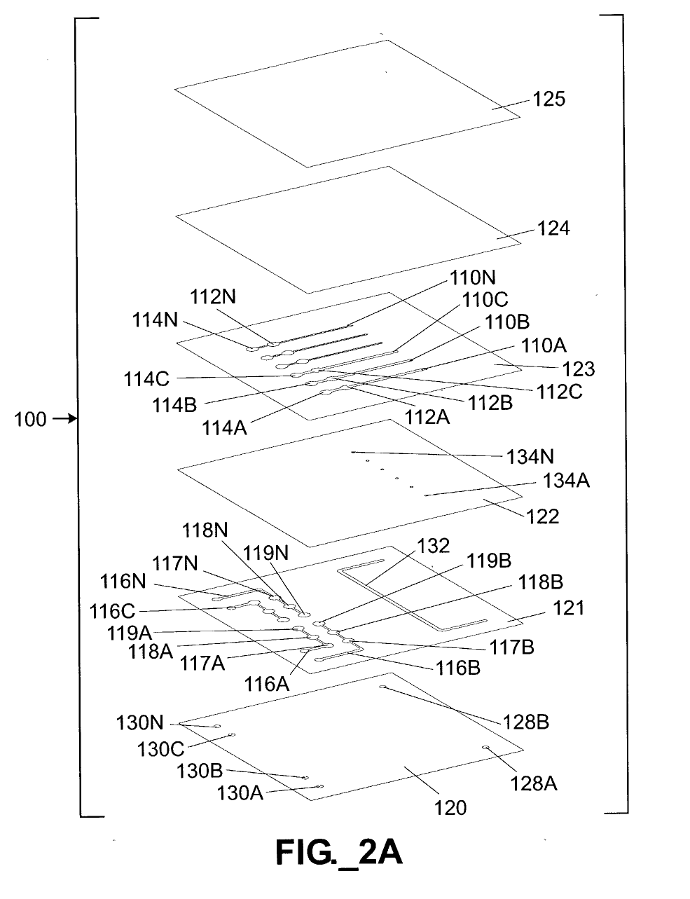

Referring to FIGS. 1A-1B, a microfluidic device 10 according to the present invention includes three device layers 17-19. The first layer 17 defines a microfluidic actuating channel 12. The third layer 19 defines a microfluidic metering channel 14. Preferably, the device 10 further includes upper and lower boundary layers (not shown) to enclose the microstructures 12, 14, 20, 22 defined in the two outermost illustrated layers 17, 19. The actuating channel 12 and metering channel 14 are physically separate, that is, there is no fluid communication between them. The metering channel 14 is in fluid communication with a larger volume of the fluid to be sampled (the “fluid source”) 16. The fluid source 16 may be any macro- or microfluidic structure, including, but not limited to a trunk channel, a reaction chamber, or a reservoir. The actuating channel 12, which can use air or liquid as an operant fluid, is separated from the metering channel 14 by third layer 18, which also is a deformable membrane.

Increasing or decreasing the pressure within the actuating channel 12 (the “actuating pressure”) causes the deformable membrane 18 to deform accordingly, thus altering the volume of the metering channel 14. The metering channel 14 is a closed-end channel, i.e., it has only one inlet. Consequently, changes in the volume of the metering channel 14 result in a pressure change in metering channel 14, creating a pressure differential between the metering channel 14 and the fluid source 16 (the “metering pressure”). The metering pressure causes a fluid plug to be drawn into or expelled from the metering channel. For example, decreases in metering pressure act to draw the fluid plug from the fluid source 16 into the metering channel 14. Increases in metering pressure act to push fluid plug from the metering channel 14 into the fluid source 16. Alternatively, a metering channel may have multiple inlets, provided there is a valve or other sealing means that allows the metering channel to be made, at least temporarily and for the duration of the metering operation, closed-ended.

One or both of the actuating channel 12 and the metering channel 14 may have control regions 20, 22 (respectively) having at least one dimension that that is significantly different than the dimensions of the channel 12, 14. For example, as shown in FIGS. 1A-1B, the control regions 20, 22 of the channels 12, 14 are circular and of equal size, both substantially larger than the remainder of the channels 12, 14. However, it will be readily apparent to one skilled in the art that the relative geometry and size of the control regions 20, 22 may be varied to achieve desired results. Volumetric differences between the two control regions 20, 22 allow small changes in actuating pressure to have either much greater or much smaller effect on the resultant draw produced by the metering channel 14. Also, significant differences in volume between the control regions 20, 22, allow for small variations in actuating pressure to have an amplified or attenuated effect on metering pressure. Thus, the gain of the system may be controlled.

For example, a large actuating channel control region 20 used in combination with a small metering control region 22 will allow small changes in control pressure to effect large changes in metering pressure, thus amplifying the control signal. Likewise, a small actuating channel control region 20 used in combination with a large metering control region 22 will allow large changes in control pressure to be made with very small resulting changes in metering pressure, thus attenuating the control signal.

When control regions are used, and particularly when metering channel control regions are substantially larger than the dimensions of the remainder of the metering channel, care should be taken to avoid drawing fluid into the control region. It may be difficult to accurately measure the volume of a fluid plug when a portion of the plug is drawn into the control region. This is because the plug may not completely fill the control region. Also, if and when the plug is expelled from the measuring channel, some of the plug may remain trapped in the control region, inducing further inaccuracy, as well as potentially contaminating plugs of other fluids subsequently drawn into the metering channel. In order to avoid these problems, the volume of the portion of the metering channel between fluid source and the control region(s) (the “metering region”) should be larger than the maximum change in volume that can be created by the associated control regions.

Microfluidic closed-end metering devices according to the invention may be incorporated into more complex structures. For example, a single actuating channel may actuate multiple metering channels. Likewise, a metering channel may be actuated by multiple actuating channels. Any number of metering channels and actuating channels, in any combination or geometry may be used to perform the desired metering and/or sequestering operations.

In addition, at least a portion of the metering region may be fabricated with a substantially optically transmissive material to permit analysis of the fluid plug while it is sequestered in the metering region. For example, the device layers may be a substantially optically transmissive polymer such as polypropylene or other suitable polymers. Alternatively, a window fabricated with quartz, glass or any other suitable material may be included in one or more of the device layers at the desired location.

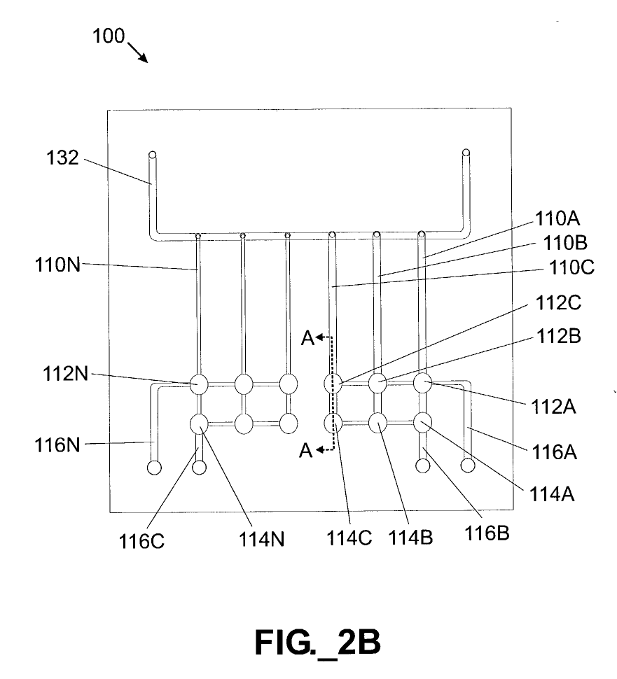

Referring to FIGS. 2A-2B, a microfluidic closed-end metering device 100 includes six metering channels 110A-110N, each with two control regions 112A-112N, 114A-114N, and four separate actuating channels 116A-116N, each with three control regions 117A-117N, 118A-118N, 119A-119N. (Although FIGS. 2A-2B show the device 100 with six metering channels 110A-110N and four actuating channels 116A-116N, it will be readily apparent to one skilled in the art that any number of metering and actuating channels may be provided. For this reason, the designation “N” is used to represent the last metering channel 110N and actuating channel 116N, with the understanding that “N” represents a variable and could represent any desired number of such channels or any other feature or structure within the device.)

The microfluidic closed-end metering device 100 is made up of six device layers 120-125. The first device layer 120 is a one sixteenth inch (1600 micron) thick acrylic substrate. The first device layer 120 defines trunk channel input/output ports (“I/O ports”) 128A-128B and actuating channel I/O ports 130A-130N.

The second device layer 121 is a double-sided tape made of a one-mil (25 micron) thick polypropylene carrier with two mils (50 micron) rubber adhesive on both sides. The second device layer 121 is a stencil layer that defines a trunk channel 132 and four separate actuating channels 116A-116N, each having three control regions 117A-117N, 118A-118N, 119A-119N. Each actuating channel 116A-116N is in fluid communication with one of the actuating channel I/O ports 130A-130N. The trunk channel 132 is in fluid communication with the trunk channel I/O ports 128A-128B.

The third device layer 122 is a one-half mil (12 micron) thick polypropylene film that defines metering channel vias 134A-134N. (A “via” is an aperture providing fluid communication between non-adjacent device layers.) At least the portion of the third device layer 122 between the actuating channel control regions 118A-118N and the measuring channel control regions 112A-112N, 114A-114N is a deformable membrane, and preferably an elastically deformable membrane (i.e., application of a force will deform the device layer 122; however, the device layer 122 will return substantially to its pre-stressed state when the force is removed) under the typical operating conditions of the device 100. In the embodiment shown in FIGS. 2A-2B, the entire third device layer 122 is fabricated with a material that functions as a deformable membrane; however, a deformable membrane region (not shown) could be inset into an otherwise non-deformable third device layer 122 in the area between the actuating channel control regions 118A-118N and the measuring channel control regions 112A-112N, 114A-114N.

The fourth device layer 123 is a double-sided tape made of a one-mil (25 micron) thick polypropylene carrier with two mils (50 micron) rubber adhesive on both sides. The fourth device layer 123 is a stencil layer that defines six metering channels 110A-110N, each with two control regions 112A-112N, 114A-114N. The metering channels 110A-110N are in fluid communication with the trunk channel 132 through metering channel vias 134A-134N.

The fifth and sixth device layers 124, 126 are fabricated with two-mil (50 micron) thick polypropylene film.

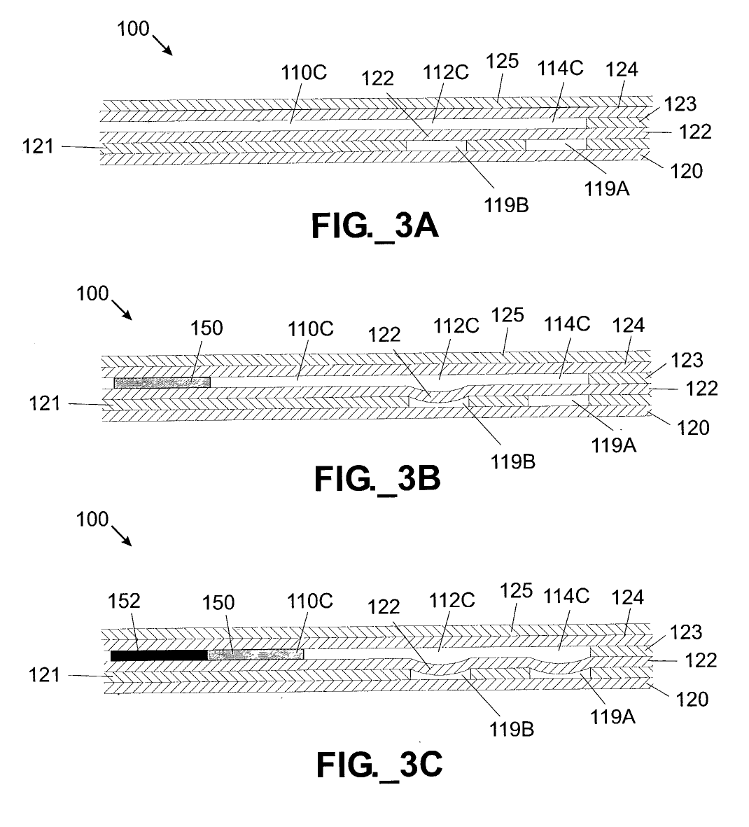

Referring to FIGS. 2A-2B and 3A-3C, in operation of the device 100, a pressure is applied to actuating channel I/O ports 130A-130N to initially pressurize actuating channels 116A-116N to approximately 10 psi. A fluid to be sampled is provided to the trunk channel 132 through trunk channel I/O ports 128A or 128B. A vacuum is applied to a first actuating channel 116A, including actuating channel control regions 117A, 118A and 119A. The flexible membrane device layer 122 between the actuating channel control regions 117A, 118A and 119A and the metering control regions 112A-112C, is drawn downward into the actuating channel control regions 117A, 118A and 119A. This deformation of the flexible membrane device layer 122 expands the volume of the metering channel control regions 112A-112C.

Because the metering channels 110A-110C are “closed-end” channels, i.e., open only to the trunk channel 132, the increased volume creates a pressure differential between the metering channels 110A-110C and the trunk channel 132. This pressure differential causes a first fluid plug 150 to be drawn from the trunk channel 132 into each of the metering channels 110A-110C. Subsequently or simultaneously, a vacuum may be applied to the remaining actuating channel 116B, thereby creating additional vacuum to draw a second fluid plug 152 into the metering channels 110A-110C. When the actuating channels 116A-116B are re-pressurized, the fluid plugs 150-152 from each of the metering channels 110A-110C are pushed back into the trunk channel 132. This can be accomplished in one step by re-pressurizing both the actuating channels 116A-116B simultaneously, or in steps, by re-pressurizing each actuation channel 116A-116B in sequence.

It will be readily apparent to one skilled in the art that any suitable mechanism for deforming the deformable membrane 122 may be employed. Alternative embodiments may include magnetic, mechanical, or electromechanical actuators. For example, a magnetic element may be incorporated in or affixed to the deformable membrane 122 and a magnetic field applied to move the membrane 122 upward or downward. Similarly, a piezoelectric element may be incorporated in the device 100, such as by being affixed to the membrane 122.

It also will be readily apparent to one skilled in the art that multiple deformable membranes may be used. For example, actuating channels may be provided above and below the metering channel, requiring at least one membrane between each actuating channel and the metering channel. Also, a single device layer may be fabricated with multiple deformable membrane segments where each segment is associated with one or more control regions and has a characteristic modulus of elasticity tailored to exhibit desired performance characteristics.

Closed-end microfluidic metering devices according to the present invention allow accurately measured microfluidic volumes of fluid to be withdrawn from and returned to a larger sample. Closed-end microfluidic metering devices according to the present invention may also serve as a means of storing multiple small samples that have been measured by another process and that need to be sequestered from the fluid source. Samples may be moved within a defined, closed area (i.e. for mixing back and forth). Samples also may be moved fixed, predetermined distances reliably and repeatedly, thus minimizing the need for complex control systems that may require timers and/or sensors.

Because closed-end microfluidic metering devices according to the present invention rely on a pressure differential between a fluid source and a metering channel to move fluid samples, the need for vents and/or gas-permeable membranes is eliminated. Thus, there is no likelihood of fluids from escaping through a vent or the system becoming inoperable or contaminated by a wetted gas-permeable membrane.

It is also to be appreciated that the foregoing description of the invention has been presented for purposes of illustration and explanation and is not intended to limit the invention to the precise manner of practice herein. It is to be appreciated therefore, that changes may be made by those skilled in the art without departing from the spirit of the invention and that the scope of the invention should be interpreted with respect to the following claims.

What is claimed is:

1. A method for metering at least one microfluidic plug from a larger fluidic volume, the method comprising the steps of:
providing a fluid source;
providing a microfluidic metering channel having an open end and a closed end, the open end being in fluid communication with the fluid source;
providing a first deformable membrane that bounds at least a portion of the metering channel; and
deforming the first deformable membrane to draw a first fluid plug from the fluid source into the metering channel.

2. The method of claim 1, further comprising the step of providing a first actuating channel, at least a portion of the first actuating channel being bounded by the first deformable membrane, wherein the step of deforming the first deformable membrane is performed by altering the pressure within the first actuating channel.

3. The method of claim 2, further comprising the steps of:
providing a second deformable membrane that bounds at least a portion of the metering channel; and
deforming the second deformable membrane to draw a second fluid plug from the fluid source into the metering channel.

4. The method of claim 3, further comprising the step of providing a second actuating channel, at least a portion of the second actuating channel being bounded by the second deformable membrane, wherein the step of deforming the second deformable membrane is performed by altering the pressure within the second actuating channel.

5. The method of claim 1, further comprising the step of providing a first magnetic element associated with the first deformable membrane, wherein the step of deforming the first deformable membrane is performed by applying a first magnetic field to the first magnetic element.

6. The method of claim 3, further comprising the step of providing a second magnetic element associated with second deformable membrane, wherein the step of deforming the second deformable membrane is performed by applying a second magnetic field to the second magnetic element.

7. The method of claim 1, further comprising the step of deforming the deformable membrane to expel the fluid plug from the metering channel.

8. A device for metering at least one microfluidic plug from a larger fluidic volume, the device comprising:
a fluid source;
a metering channel having an open end and a closed end, the open end being in fluid communication with the fluid source; and
a first deformable membrane bounding at least a portion of the metering channel;
wherein the first deformable membrane is adapted to selectively alter the volume of the metering channel to create a first pressure differential between the metering channel and the fluid source.

9. The device of claim 8, further comprising a first actuating channel, at least a portion of the first actuating channel being bounded by the first deformable membrane.

10. The device of claim 8, further comprising a second deformable membrane bounding at least a portion of the metering channel, wherein the second deformable membrane is adapted to selectively alter the volume of the metering channel to create a second pressure differential between the metering channel and the fluid source.

11. The device of claim 10, further comprising a second actuating channel, at least a portion of the second actuating channel being bounded by the second deformable membrane.

12. The device of claim 10 wherein the first deformable membrane and the second deformable membrane are substantially continuous.

13. The device of claim 8, further comprising a first magnetic element associated with the first deformable membrane.

14. The device of claim 10, further comprising a second magnetic element associated with the second deformable membrane.

15. The device of claim 8, wherein the metering channel includes an analytical region.

16. The device of claim 15 wherein the analytical region is substantially optically transmissive.

17. The device of claim 8 wherein the device is fabricated from a plurality of device layers.

18. The device of claim 17 wherein any of the device layers is a stencil layer.

19. The device of claim 17 wherein any of the device layers is fabricated with a polymer.

20. The device of claim 19 wherein the polymer is substantially clear.

21. The device of claim 19 wherein the polymer is selected from the group consisting of:
polyolefins and vinyl-based (alkene-based) polymers.

22. The device of claim 17 wherein any of the device layers is fabricated with a self-adhesive tape material.

23. The device of claim 8 wherein the fluid source is a microfluidic channel.

24. The device of claim 8 wherein the fluid source is a macrofluidic channel.

25. The device of claim 8 wherein the fluid source contains a substantially continuous flow of a liquid.

26. The device of claim 8 wherein first deformable membrane is elastically deformable.

27. A device for metering a plurality of microfluidic plugs from a larger fluidic volume, the device comprising:
a fluid source;
a plurality of metering channels, each having an open end and a closed end, the open end of each metering channel of the plurality of metering channels being in fluid communication with the fluid source; and
a first deformable membrane bounding at least a portion of each metering channel of the plurality of metering channels;
wherein the first deformable membrane is adapted to selectively alter the volume of each metering channel of the plurality of metering channels to create a first pressure differential between each metering channel of the plurality of metering channels and the fluid source.
